(19) United States
(12) Patent Application Publication
(10) Pub. No.: US 2004/0158540 A1
(43) Pub. Date: Aug. 12, 2004

(54) Spam control system requiring unauthorized senders to pay postage through an internet payment service with provision for refund on accepted messages

(75) Inventor: Lianghe Zuo, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Cashette, Inc., Fremont, CA

(21) Appl. No.: 10/643,735

(22) Filed: Aug. 19, 2003

Related U.S. Application Data
(63) Continuation-in-part of application No. 10/066,517, filed on Jan. 31, 2002.

(51) Int. Cl. G06F 17/60

(52) U.S. Cl. 705/408; 705/401; 705/1

(57) ABSTRACT

An e-mail service system that maintains close cooperative interaction with a payment service system to provide the capability to control unsolicited e-mail messages commonly known as spam is coupled to an independent e-mail provider, typically by the ID/e-mail address and password on that independent e-mail account. Upon receiving messages from the independent e-mail provider, the e-mail service system checks whether this sender either has paid at least the preset amount by the recipient or is on the recipient's exception list. If both are negative, the e-mail will be rejected with an e-mail notification. The rejection e-mail can be sent to this sender of the original e-mail either directly from the e-mail service system or alternatively through the independent e-mail system. The payment to the recipient can be automatically cancelled when the recipient replies to the e-mail or adds the sender to the exception list.

This application is a Continuation-in-Part of my U.S. patent application Ser. No. 10/066517 filed Jan. 31, 2002 entitled Spam Control System Requiring Unauthorized Senders to Pay Postage through an Internet Payment Service with Provision for Refund on Accepted Messages.

The present invention relates to a method and system for controlling the delivery of unsolicited electronic mail messages over an electronic communications network such as the Internet. More particularly, postage has to be paid, through an Internet payment service system in close cooperation with the e-mail service system, on unsolicited spam e-mail with provision for postage refund on accepted or replied to messages. In this Continuation-In-Part, I route e-mail for an e-mail account with an independent e-mail provider through my method and system so that general e-mail accounts can be provided with spam control through the method and system of my original invention.

### BACKGROUND OF THE INVENTION

Users of electronic mail are plagued with unwanted, unsolicited e-mail messages broadcast to large numbers of e-mail addresses. This e-mail is commonly known as “spam.”

Electronic mass marketers (called “spammers”) who broadcast such spam use a variety of sources for obtaining e-mail address lists. Further, merchants selling product, such as software frequently solicit e-mail addresses as part of their “registration” protocol.

For example, purchasers of software are almost always asked for their e-mail address. The purchaser is immediately given a dilemma. If the purchaser fails to supply his e-mail address, important notifications relating to the software product purchased will fail to be timely delivered. If the purchaser does supply his e-mail address, along with any important notifications relating to the software product purchased will come unwanted and undesired “spam” e-mail.

Users of the Internet services and electronic mail, as well as their employers or Internet service providers, are not eager to have “spam” type e-mails delivered in large quantities to their computers. Simply stated, the sorting of junk e-mail becomes an organization wide drag on productivity. Such junk e-mail is further a daily annoyance to the recipients whether in a business environment or at home.

The prior art has recognized the seriousness of this problem. For example, Paul U.S. Pat. No. 6,052,709 entitled “Apparatus and Method for Controlling Delivery of Unsolicited Electronic Mail” utilizes so-called “spam probe e-mail addresses.” In this system, artificial addresses are delivered to Internet sites where electronic mass marketers (spammers) obtain their address information. When the spam probe e-mail addresses receive e-mail, these artificial addresses or spam probe e-mail addresses then report to a central controller having a spam blocking system. The central controller first analyze the e-mail to identify whether the e-mail is likely to be spam. If so, the central controller can either discard or sort the suspected spam e-mail to a separate folder. Network blocking of spam results.

Greenstein U.S. Pat. No. 6,266,692 entitled “Method for Blocking All Unwanted E-mail Using a Header-Based Password” utilizes pass codes associated with the e-mail addresses. Messages with incorrect pass codes are deleted. Messages without pass codes are held for a short period of time, until they are either approved for receipt or deliberately deleted. Various protocols for obtaining the pass codes are set forth.

Fleming, III U.S. Pat. No. 6,249,805 entitled “Method and System for Filtering Unauthorized Electronic Mail Messages” utilizes a “junk mail” folder. All e-mail from unauthorized addresses is automatically directed to the junk mail folder. Eventual sorting of the junk mail folder is required.

Horvitz et al. U.S. Pat. No. 6,161,130 screens messages with a “probabilistic classifier.” In this system, incoming suspected spam e-mails are content screened. Those messages having inappropriate content are automatically discarded. The probabilistic classifier is re-trained for improved spam e-mail recognition.

These systems all have their drawbacks. So-called “spam probe e-mail addresses” are randomly placed and as a result of this random placement, are unfortunately random in their detecting suspected spam e-mail. Moreover, so-called pass codes systems and junk mail folder systems all require eventual sorting. So-called “automatic screening” can result in the deletion of desired e-mail; for example, deletion of notification from software suppliers of important product information can result.

### BRIEF SUMMARY OF THE ORIGINAL DISCLOSURE

In my original disclosure, an e-mail service system maintains close co-operative interaction with a payment service system to provide the capability to control unsolicited e-mail messages commonly known as spam. The e-mail service system maintains an exception list for each e-mail account protected by the spam control service (typically the account holder's address book) and automatically delivers e-mail from all sources connected with the exception list. E-mail from addressers not on the exception list of the addressee is delivered to the recipient protected by the spam control service if the required postage is paid. If the addresser is not on the recipient's exception list and has not paid the required postage, an e-mail is sent to the addresser informing that, without required postage payment, message delivery to the protected e-mail account will not occur. Each account holder can set the required postage amount or, alternatively, the system administrator of the company, in case of a company e-mail account, can set it. Each addresser decides whether he makes the required payment for each e-mail message he sends. Provision can be made for the payment service system to credit the account of the addressee with all, a fraction, or none of the “postage” received from the addresser. Postage refund to the sender can occur responsive to two scenarios. First, if the addressee replies to an e-mail with postage, the postage payment will be automatically refunded provided such reply occurs within a predetermined period of time.

Second, editing of the exception list to include the e-mail address of the sender can operate to refund postage to the sender provided such editing occurs within a predetermined period of time. Provision is made for the recipient to directly edit the exception list of his own account.

Provision can also be made to include automatically in the exception list anyone to whom the account holder has sent any e-mail. Postage refund is of great significance for the system to be useful in real application as otherwise many non-spam e-mail senders may not send the message when they are not on the intended recipient's exception list due to the cost to send the message, which in turn will prevent e-mail account holders to use spam control service for fear of not receiving desired messages.

It will be understood that the original disclosure provides a payment or postage based solution to the persistent and widespread problem of unsolicited electronic mails (e-mails), especially those that are of an advertising nature and sent to a large number of recipients. While the preferred embodiment shows an e-mail service system, in co-operative interaction with a payment service system, it will be understood that the two systems may be combined into one.

The employment of a general payment service system offers many advantages. Since a payment system may have been made for other purposes, the cost for the spam control service can be reduced and the deployment of the service can be much easier. Users who have already opened an account with the general payment service system will not have to open and maintain a separate account for spam control purpose. If he open an account for spam control purpose, he can also use the account for general payment service purposes. It should be noted that the payment service system can be for postage payment only although it may be advantageous to use it for some other payment purposes as well.

Each individual account holder typically determines the postage required to deliver unsolicited e-mail messages to that account. The network operator of the individual's company or Internet service provider may also determines the postage in case of a company e-mail account.

The disclosure provides an exception list, which is edited and controlled either by the individual or the network operator of the recipient. Editing of the exception list by the network operator may be desired in the case of a company e-mail account. Systems for the automatic cancellations of charges are responsive to either adding the sender to the exception list or reply by the recipient to the sender within a predetermined period of time. Provision can be made that the recipient can manually reverse the payment as well.

### BRIEF SUMMARY OF THE INVENTION OF THE CONTINUATION-IN-PART

An e-mail service system that maintains close cooperative interaction with a payment service system to provide the capability to control unsolicited e-mail messages commonly known as spam is coupled to an independent e-mail provider, typically by the ID/e-mail address and password on that independent e-mail provider account. Upon retrieving messages from the independent e-mail provider, the e-mail service system checks whether this sender either has paid at least the preset amount by the recipient or is on the recipient's exception list. If both are negative, the e-mail will be rejected with an e-mail notifications stating the reason of rejection and what is required to send an e-mail to this recipient. The rejection e-mail can be sent to this sender of the original e-mail either directly from the e-mail service system or alternatively through the independent e-mail system.

### BRIEF DESCRIPTION OF THE DRAWINGS

FIG. 1 is a block diagram schematically setting forth the interaction between the e-mail service system and the payment service system illustrating transaction flow between a sender and protected recipient;

FIG. 2 is a block diagram schematically setting forth the interaction between the e-mail service system and the payment service system illustrating two “postage” canceling protocols including a postage refund responsive to a recipient's reply to an e-mail from a source not on the exception list and a postage refund responsive to adding the sender to the exception list;

FIG. 3 is a schematic representation of an e-mail program window with a “postage” button allowing the sender to click on it to bring up the window shown in FIG. 4 to designate the postage the sender is willing to pay to insure receipt of his e-mail;

FIG. 4 is a schematic of a dialog box at the sender's computer to enable the sender to designate the postage he is willing to pay to have his e-mail delivered to the recipient when the sender is not on the recipient's exception list; and,

FIG. 5 is a block diagram added with this Continuation-in-Part schematically setting forth the interaction between the independent e-mail provider, the e-mail service system and the payment service system illustrating transaction flow between a sender and protected recipient;

FIG. 6 is a block diagram added with this Continuation-in-Part schematically setting forth the interaction between the independent e-mail provider, the e-mail service system and the payment service system illustrating two “postage” canceling protocols including a postage refund responsive to a recipient's reply to an e-mail from a source not on the exception list and a postage refund responsive to adding the sender to the exception list.

### DETAILED DESCRIPTION OF THE INVENTION

In the following specification the term “sender” or “addresser”0 will refer to the sender of an electronic mail, whether that message is sent to one or multiple recipients.

“Recipient” or “addressee” will refer to one of the intended recipient(s) of the e-mail. Note that an e-mail account or user is typically enabled to be either a sender or a recipient or both.

“Postage” or “spam fee” will refer to a payment that an unauthorized sender has to make in order to ensure that the e-mail reaches a particular recipient.

The term “e-mail service system” refers to any system that handles sending and receiving of e-mail messages through a network whether or not it has other added functions.

The term “payment service system” refers to any system that handles sending and receiving of payment whether or not it has other added functions.

The term “spam control system” refers to the interactive combination of the e-mail service system, the exception list, and the independent e-mail provider.

The term “exception list” is a list containing e-mail addresses from which e-mails can be sent to the owner of such a list without the payment of postage. This list may contain other information related to those e-mail addresses; such as but not limited to, names, phone numbers, and addresses.

The term “reply e-mail” refers to, after an e-mail is sent from the sender to the recipient, an e-mail sent from the recipient of the original e-mail to the sender of the original e-mail, whether or not it is intended as a reply.

The reader will understand that the e-mail service system can be combined with the general payment service system, dependent upon the convenience of the operator of this system.

Having defined the terms, the operation of the preferred embodiment can now be set forth.

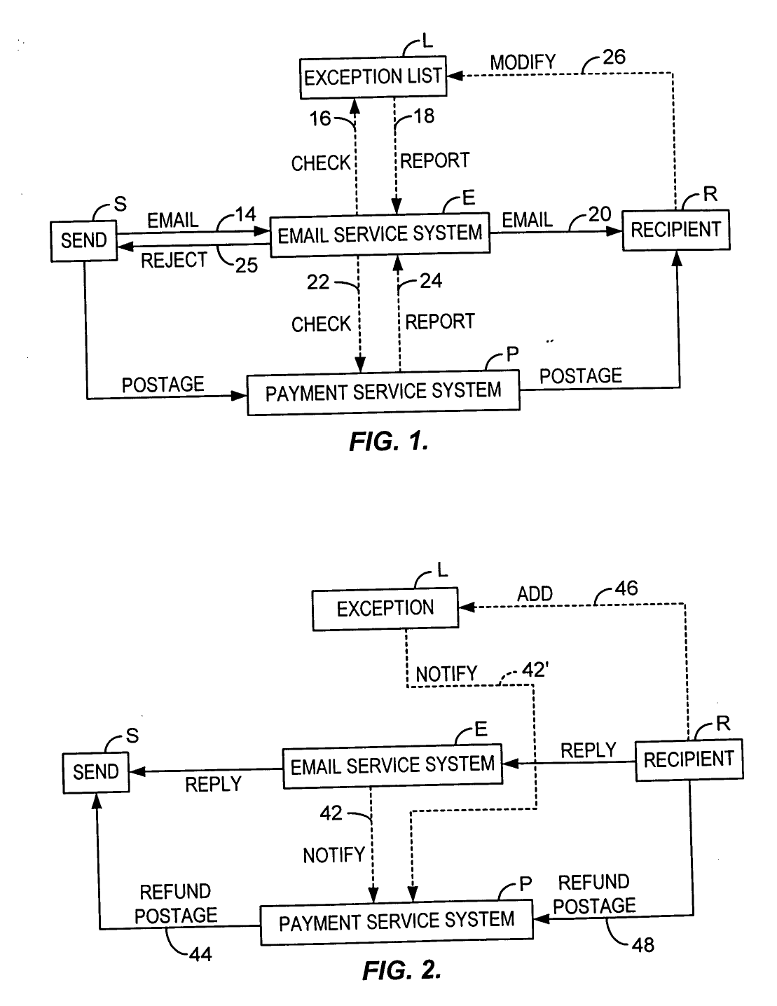

Referring to FIG. 1, sender S sends an e-mail to e-mail service system E through e-mail route 14. E-mail service system E compares the identity of the addresser (sender S) to the exception list L of the recipient. Two possible conditions can exist.

First, the e-mail address of sender S can be on the exception list. In this case responsive to check 16, report 18 from the exception list L will be favorable. E-mail will be forwarded to recipient R at e-mail route 20. Second, the e-mail address of sender S can be absent from the exception list L. In this case, a report 18 from the exception list L will be negative causing the e-mail service system E to send a check 22 to payment service system P.

At this juncture, two possibilities exist. A payment of spam fee or postage of at least the amount preset by the recipient may have been paid by the sender S to the recipient R. If this is the case, a positive report 24 will be sent to e-mail service system E causing e-mail service system E to release the e-mail on route 20 to the recipient R. Alternatively, the sender S may have paid the recipient R less than the amount of postage preset by the recipient R or have made no payment at all. In this case, a negative report 24 will be sent to e-mail service system E. A negative report 24 will cause the e-mail service system E to send an e-mail notification (Reject E-mail 25) to the sender S stating that the e-mail cannot be sent the intended recipient without the required postage payment.

The postage, when required, can be paid either separately or along with the e-mail. An e-mail program can be developed to allow simultaneous sending of both the postage and the e-mail. If the postage is sent separately, the payment must have been made by the time the e-mail is sent. No delayed payment based on billing or promise to pay is accepted, as those are not only burdensome but also often unenforceable.

It will be understood that exception list L can be edited by recipient R (see path 26). The list can include any or all business and personal connections of his choosing. The exemption list is based on the individual's e-mail address book with the capability of being modified by not only the account holder but also anyone having authorized access to that list including network administrator and/or employer in case of a company e-mail account. The spam control service provider can also add to the exception list anyone to whom the account holder has sent an e-mail.

It will be appreciated that sender S's e-mail may have been personal or business-related and not related in anyway to unsolicited volume advertisements such as spam. This being the case, sender S will have paid a (nominal) fee to ensure delivery of his e-mail. However, the recipient R can reverse the “postage” payment as shown in FIG. 2.

Referring to FIG. 2, two scenarios are illustrated for the postage refund. First, it is assumed that recipient R reply to the e-mail of sender S (it will be remembered that his e-mail was delivered because of its postage). Upon reply, e-mail service system E notifies payment service system P along path 42. The postage refund is sent along path 44 and 48. Alternately, recipient R can edit exception list L through path 46. In this case, the change of exception list L to include the address of sender S is noted to payment service system P along path 42′. The postage payment is refunded in this case as well.

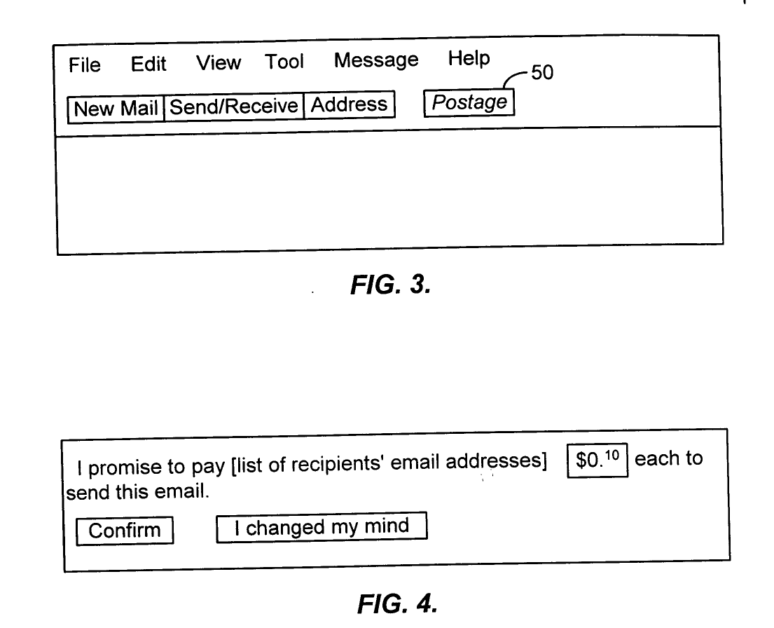

Referring to FIG. 3, a schematic of an e-mail program window appearing on the computer of the sender S is shown. Clicking the mouse on the area 50 marked “Postage” will cause the dialog box illustrated in FIG. 4 to appear. Utilizing this dialog box, the sender can designate the postage that he or she is willing to pay.

Likewise, it will be understood that recipient R can set a payment threshold to suit his particular circumstance. Only postage payment that meets or exceeds this threshold will cause the system to deliver the e-mail message associated with that postage to be delivered to the intended recipient(s). Alternatively, this payment threshold can be set by the network administrator or employer in case of a company e-mail account.

It will be understood that every account is enabled as either a sender S or a recipient R. This feature is convenient for the sender S, the recipient R, and the proprietor of payment service system P.

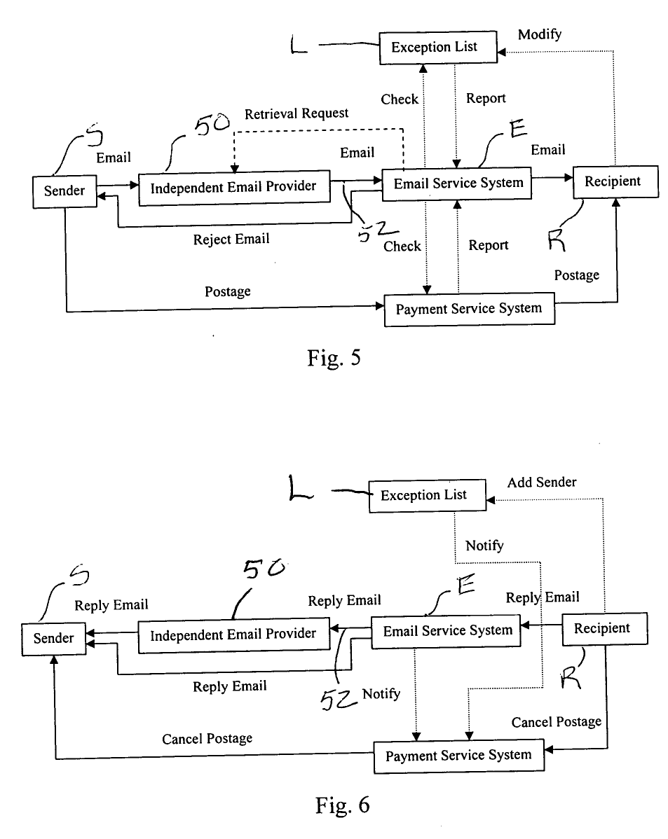

Referring to FIG. 5 an independent e-mail provider 50 is shown linked between the sender S and e-mail service system E. The E-mail Service System further communicate with an independent e-mail provider(s) 50 with a protocol such as POP3 to retrieve e-mails along path 52 from the independent e-mail provider provided that a user of the e-mail service system has an e-mail account with the independent e-mail provider and has provided the ID/e-mail address and password of that account to the e-mail service system E. The retrieval can be done either periodically or at the time when a user checks his/her e-mails or both. Upon the retrieval, the e-mail service system can inform the independent e-mail provider to either delete the retrieved messages from the independent e-mail provider 50. The retrieved messages may also be left in the system of the independent e-mail provider 50. In this case, the e-mail messages left in the system of the independent e-mail provider 50 are not spam-controlled and the user should be instructed that he should access his e-mail at the email service provider E to get the spam-control benefits. Another alternative is for the spam-control system to inform the independent e-mail service provider 50 to delete only the e-mail messages that the spam-control system will reject according to the standard set forth in the following paragraph.

When the e-mail service system retrieves an e-mail sent to a user's e-mail account at the independent e-mail provider, the e-mail service system will check whether the sender either has paid at least the pre-set amount by the recipient or is on the recipient's exception list L. If at least one of them is affirmative, the e-mail will be sent to the recipient. If both are negative, the e-mail will be rejected with an e-mail notification stating the reason of rejection and what is required to send an e-mail to this recipient. The rejection e-mail can be sent to the sender of the original e-mail either directly (as shown in the above flow chart) or through the independent e-mail system.

In order for the sender to be able to pay the recipient postage, the spam control system must be able to identify its user by his e-mail address from independent e-mail provider. This is necessary as the sender may be sending e-mail to the recipient's e-mail address with the independent e-mail provider but not necessarily the recipient's e-mail address with the spam control system.

The user can read (and compose), through the e-mail service system, all e-mails for his e-mail accounts with the independent e-mail providers together with his e-mails with the e-mail service system. The user's e-mail account with the independent e-mail provider benefits from the spam-control feature only if he read the e-mails with independent e-mail provider after they are retrieved by the e-mail service system. If the e-mails are read on the independent e-mail provider before the retrieval takes place, spam control benefit will not occur for those e-mail messages that have not been retrieved and spam-controlled. The spam control service provider can choose to either eliminate that problem by requiring its users to read all e-mails through the e-mail service system or minimize that problem by retrieving very frequently from the independent e-mail provider.

The automatic spam-control postage cancellation allows one who is not on the recipient's exception list L to send e-mail to the recipient R without cost. This is particularly useful for those who have personal or business connection with the recipient but not on the recipient's exception list yet.

Referring to FIG. 6, this invention extends the original invention's capability to automatically refund the sender S to the scenario when the e-mail address of the recipient R is that with the independent e-mail provider 50. The postage payment can be automatically refunded to the sender S if the recipient R, within a pre-determined period of time, reply to the sender S or manually put the sender S on his exception list L. Of course, the recipient R can always choose to manually reimburse (not shown in FIG. 6) the sender's postage as well either before or after the predetermined period of time ends.

In order for the cancellation triggered by reply to the sender S to work, the user should compose such reply e-mail messages on the e-mail service system E instead of the independent e-mail system 50 or the e-mail service system E should retrieve “sent mails” periodically while the user is required not to delete “sent mails” within a short period of time after the mail is sent.

The e-mail service system E can further provide the capability for the user to send e-mail from the e-mail service system E with a return (or “from:”) e-mail address of either the e-mail service system E or the independent e-mail provider 50.

What is claimed is:

1. A method for blocking unauthorized e-mail to at least one e-mail account comprising the steps of:
providing an e-mail service system for receiving and routing e-mails to the at least one e-mail account;
providing an independent e-mail provider for receiving and routing e-mails to the at least one independent e-mail account;
interrogating the independent e-mail account on the independent e-mail provider from the e-mail service system to route and receive e-mail messages in the independent e-mail account to an e-mail account on the e-mail service system;
maintaining for each e-mail account an exception list of authorized addressers identified by at least their e-mail addresses;
providing a payment service system in cooperative operation with the said e-mail service system for executing a required payment from a unauthorized e-mail sender to assure delivery of e-mail to an intended recipient;
receiving e-mail at the e-mail service system from an addresser and comparing the address of the addresser of the e-mail to the maintained exception list of the intended recipient's account;
upon finding the address of the addresser of the e-mail on the exception list, forwarding the e-mail to the intended recipient;
upon not finding the address of the addresser of the e-mail on the exception list, checking with the payment service system to see if the addresser has made at least the required payment for forwarding an e-mail to the intended recipient.;
upon finding that the addresser has made at least the required payment for forwarding an e-mail to the intended recipient, forwarding the e-mail to the intended recipient; and,
upon not finding that the addresser has made at least the required payment for forwarding an e-mail to the addressee, informing the addresser by e-mail that, without the required payment, forwarding an e-mail message from an addresser who is not on the addressee's exception list will not occur.

2. The method for blocking unauthorized e-mail to at least one e-mail account according to claim 1 and wherein the step of, upon not finding that the addresser has made at least the required payment for forwarding an e-mail to the addressee, informing the addresser by e-mail that, without the required payment, forwarding an e-mail message from an addresser who is not on the addressee's exception list will not occur occurs directly from e-mail service system to the sender of the original e-mail.

3. The method for blocking unauthorized e-mail to at least one e-mail account according to claim 1 and wherein the step of, upon not finding that the addresser has made at least the required payment for forwarding an e-mail to the addressee, informing the addresser by e-mail that, without the required payment, forwarding an e-mail message from an addresser who is not on the addressee's exception list will not occur occurs from e-mail service system to the sender of the original e-mail through the independent e-mail provider.

4. The method for blocking unauthorized e-mail to at least one e-mail account according to claim 1 and including an additional step of:
upon receiving and forwarding a reply e-mail from the addressee of a previous e-mail to the addresser of the previous e-mail, reversing the payment made by the sender of the previous e-mail if the sender of the previous e-mail made the required payment to assure the delivery of the previous e-mail to its addressee and the said reply e-mail is sent within a predetermined period of time.

5. The method for blocking unauthorized e-mail to at least one e-mail account according to claim 1 and including an additional step of:
upon receiving and executing a request from the addressee of an e-mail to add to his exception list the address of the addresser who made at least the required payment to assure the delivery of the said e-mail to its addressee, reversing the payment made by the addresser if the said request from the addressee is made within a predetermined period of time.

6. The method for blocking unauthorized e-mail to at least one e-mail account according to claim 1 and wherein the step of maintaining an exception list for each e-mail account includes:
providing the capability to add all or some of the addresses in the account holder's address book in the independent e-mail provider to the exception list.

7. The method for blocking unauthorized e-mail to at least one e-mail account according to claim 1 and wherein the step of maintaining an exception list for each e-mail account includes:
providing the capability to manually add addresses to or delete addresses from the exception list.

8. The method for blocking unauthorized e-mail to at least one e-mail account according to claim 1 and wherein the step of providing a payment service system in cooperative operation with the said e-mail service system for executing a required payment from a unauthorized e-mail sender to assure delivery of his e-mail to an intended recipient includes:
providing at least one electronic form with at least one field of entry for the account holder's e-mail service provider to set the amount of the required payment for delivery of an e-mail from an unauthorized addresser to the said account holder's e-mail account.

9. The method for blocking unauthorized e-mail to at least one e-mail account according to claim 1 and including an additional step of:
providing at least one electronic form with at least one field of entry where the addressee can provide password, ID, and other necessary information of the independent email account with the independent e-mail provider such that the step of interrogating the independent e-mail account at the independent e-mail provider from the e-mail service system to route and receive e-mail messages in the independent e-mail account to an e-mail account on the e-mail service system can occur.

10. Apparatus for blocking unauthorized e-mail to at least one e-mail recipient comprising:
an e-mail service system for receiving and routing e-mails to the at least one e-mail recipient;
an exception list of authorized addresses for e-mail recipients maintained at the e-mail service system;
an independent e-mail provider;
means for interrogating the independent e-mail provider from the e-mail service system whereby received e-mail messages in the independent e-mail account with the independent e-mail provider is routed to the e-mail account on the e-mail service system;
a payment service system for executing a required payment from a unauthorized e-mail sender to assure delivery of e-mail to an intended recipient;
the e-mail service system including means for receiving e-mail from an addresser and comparing the address of the addresser of the e-mail to the maintained exception list including means upon finding the address of the addresser of the e-mail on the exception list, forwarding the e-mail to the recipient,
an interactive connection between the e-mail service system and the payment service system to enable the e-mail service system upon not finding the address of the addresser of the e-mail on the exception list to interact with the payment service system to see if the addresser has made at least a payment required for forwarding an e-mail to the addressee from an addresser who is not on the exception list of the addressee;
means at the e-mail service system upon finding that the addresser has made at least the required payment for forwarding an e-mail to the addressee; and,
means at the e-mail service system upon not finding that the addresser has made at least the required payment for forwarding an e-mail to the addressee from an addresser who is not on the exception list of the addressee to informing the addresser by e-mail of the required payment for forwarding an e-mail message to the addressee.
